(19) United States
(12) Patent Application Publication
(10) Pub. No.: US 2005/0279892 A1
(43) Pub. Date: Dec. 22, 2005

(54) Radiator hose bracket

(76) Inventors: Zdravko Kovac, Chesterfield, MI (US); Jason A. Meyers, Utica, MI (US); Girishsingh A. Mokashi, Sterling Heights, MI (US)

Correspondence Address: HARNESS, DICKEY & PIERCE, P.L.C., P.O. BOX 828, BLOOMFIELD HILLS, MI, 48303, US

(21) Appl. No.: 10/870,679

(22) Filed: Jun. 17, 2004

(51) Int. Cl. F16L 3/08

(52) U.S. Cl. 248/65

(57) ABSTRACT

A radiator hose bracket for retaining a radiator hose relative to an engine block of a vehicle. The radiator hose bracket includes an injection molded main bracket member having a C-shaped hose clamping portion. The C-shaped hose clamping portion is sized to laterally retain the radiator hose and permit free longitudinal movement of the radiator hose. An aperture extends through the main bracket member for coupling the main bracket member to the engine block. Anti-rotation features are integrally formed with the main bracket member to prevent rotation of the main bracket member relative to the engine block.

### FIELD OF THE INVENTION

The present invention relates to mounting brackets and, more particularly, relates to a radiator hose mounting bracket for retaining a radiator hose in a desired location within an engine compartment.

### BACKGROUND OF THE INVENTION

As is known, radiator hoses of automotive vehicles are often subjected to catenary movement during vehicle movement induced by road vibration, engine roll, internal fluid pressure fluctuations, and similar movement inducing forces. This movement can often lead to premature wearing of the radiator hose and possible leakage of the radiator hose as the radiator hose contacts adjacent components within the engine compartment. Additionally, such movement may loosen any hose connections or electrical wiring nearby.

Attempts have been made to provide a radiator hose support, however such attempts have failed to provide a support capable of positively and reliably retaining the radiator hose. In other words, known supports were simply that—a support capable of supporting the weight of the hose, but incapable of properly and reliably holding the hose in position.

Accordingly, there is a need in the relevant art to provide a radiator hose bracket that is capable of positively and reliably retaining a radiator hose in an engine compartment during vehicle operation. Additionally, there exists a need in the relevant art to provide a radiator hose bracket is this capable of meeting the currently unaddressed needs in the art.

### SUMMARY OF THE INVENTION

According to the principles of the present invention, a radiator hose bracket for retaining a radiator hose relative to an engine block of a vehicle is provided having an advantageous construction. The radiator hose bracket includes an injection molded main bracket member having a C-shaped hose clamping portion. The C-shaped hose clamping portion is sized to laterally retain the radiator hose, yet permit free longitudinal movement of the radiator hose. An aperture extends through the main bracket member for coupling the main bracket member to the engine block. Anti-rotation features are integrally formed with the main bracket member to prevent rotation of the main bracket member relative to the engine block.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view illustrating a first side of a radiator hose bracket according to the present invention;

FIG. 2 is a perspective view illustrating a second side of the radiator hose bracket;

FIG. 3a is a perspective view illustrating the radiator hose bracket operably mounted to a first engine block;

FIG. 3b is a perspective view illustrating the radiator hose bracket operably mounted to a second engine block; and

FIG. 3c is another perspective view illustrating the radiator hose bracket operably mounted to the first engine block.

### DETAILED DESCRIPTION OF THE PREFERRED EMBODIMENT

The following description of the preferred embodiment is merely exemplary in nature and is in no way intended to limit the invention, its application, or uses.

Referring to the figures, a radiator hose bracket assembly 10 generally includes an injection-molded main bracket member 12 for restraining the movement of radiator hose 14 of a vehicle. Main bracket member 12 encapsulates radiator hose 14 of the vehicle to restrain such movement, which might stress radiator hose 14 mounts or damage radiator hose 14 by allowing it to wear against the design environment, such as the radiator fan, supports, or other engine components.

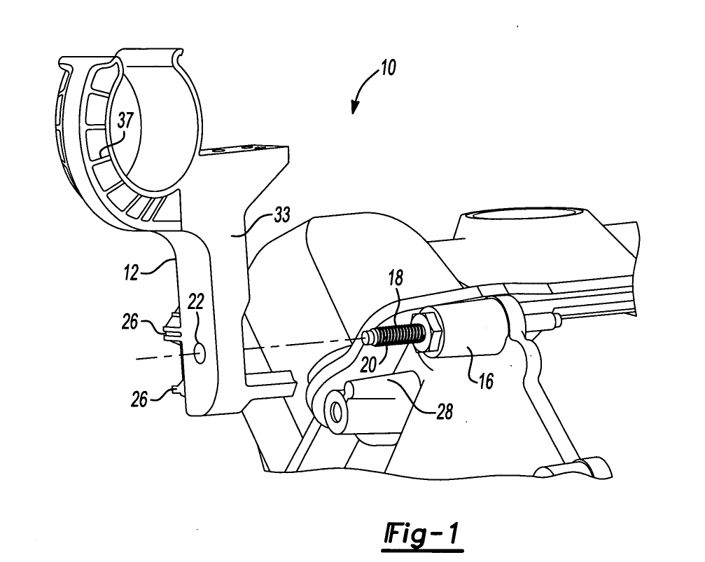

Main bracket member 12 of radiator hose bracket assembly 10 is mounted to an engine block 16 via a fastener 18. More specifically, as seen in FIG. 1, fastener 18 is a double-ended threaded fastener that is threadedly engaged with engine block 16 and further provides an extending threaded portion 20. Main bracket member 12 includes a mounting aperture 22 formed therethrough for receiving extending threaded portion 20. A nut 19 is then tightened upon extending threaded portion 20 to retain main bracket member 12 securely in place relative to engine block 16.

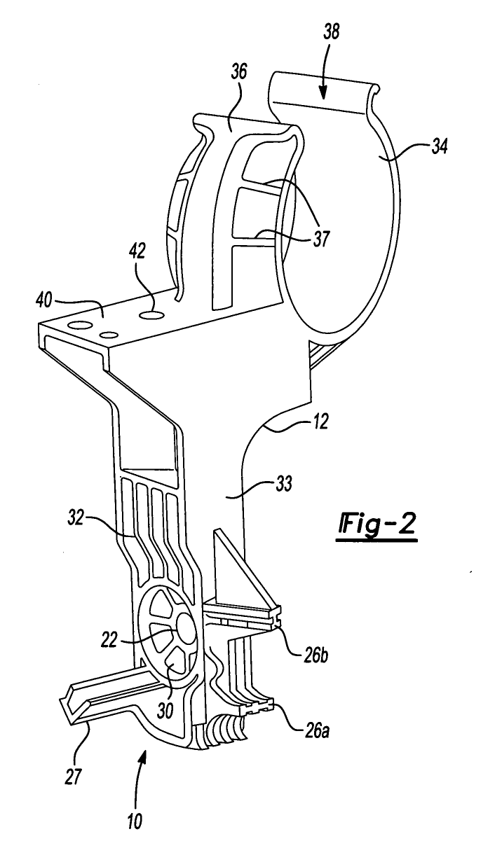

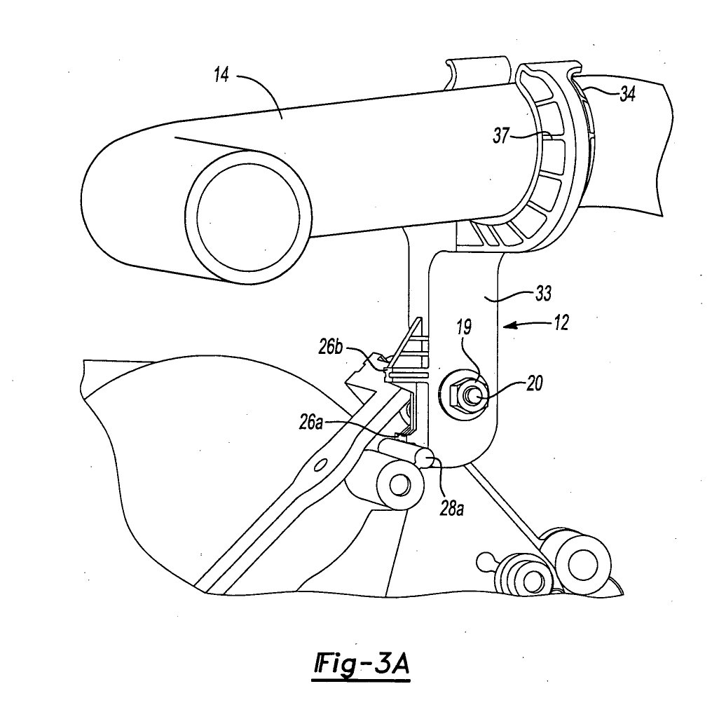

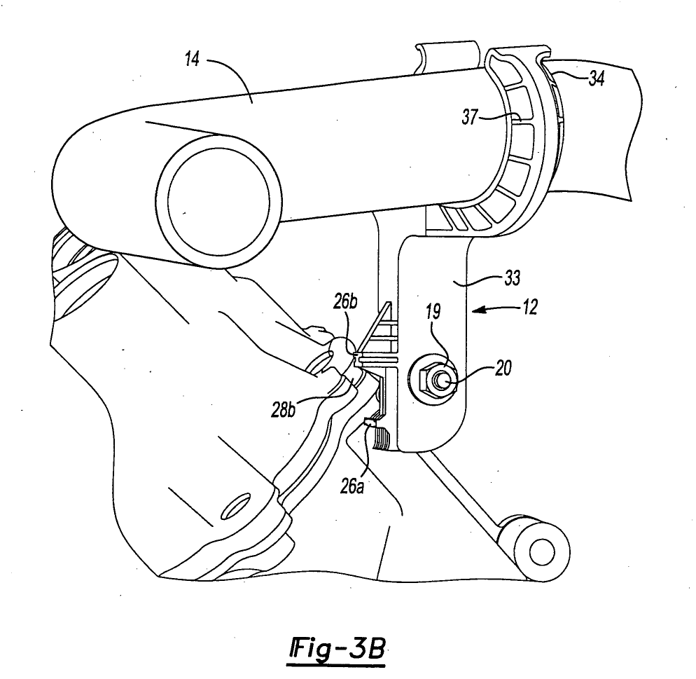

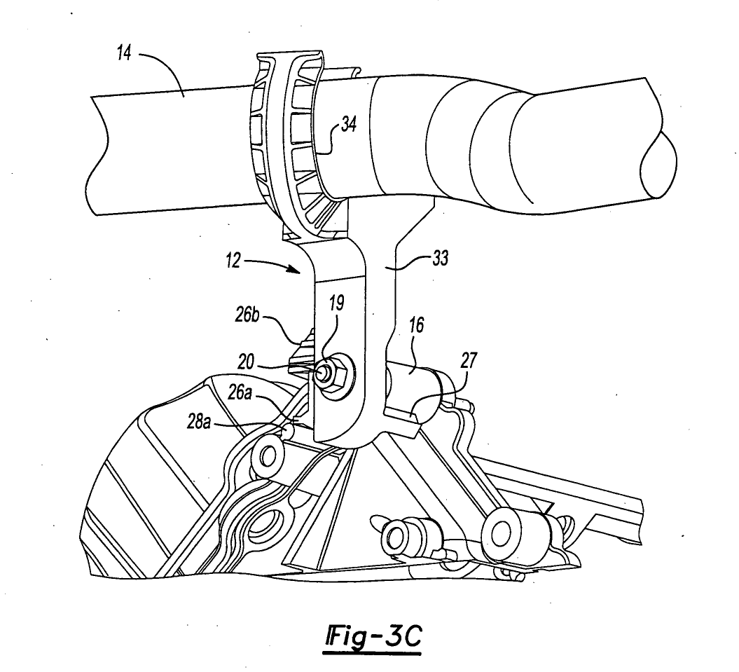

As best seen in FIGS. 2, 3a, 3b, and 3c, anti-rotation features, namely finger members 26a, 26b, extend from and are integrally formed with main bracket member 12. Finger members 26a, 26b extend in a direction generally orthogonal to an axis of mounting aperture 22. Each of finger members 26a, 26b engages a corresponding features 28a, 28b on engine block 16 to prevent rotation of main bracket member 12 relative to engine block 16. More particularly, main bracket member 12 is adapted with be used with varying vehicle models. Each of these vehicle models may have a different engine block configuration that necessitates the need for finger members to be places in varying locations. It should be appreciated that main bracket member 12 could have a single finger member if it is to be used on a single vehicle. Referring now to FIGS. 3a and 3b, it can be seen that finger member 26a is adapted to engage corresponding feature 28a and finger member 26b is adapted to engage corresponding feature 28b, respectively. As seen in FIG. 3c, additional anti-rotation features may be used, such as an elongated prong member 27 that is formed integrally with main bracket member 12. Prong member 27 defines a longitudinal axis that is generally parallel to the axis of mounting aperture 22 yet is capable of engaging engine block 16.

Radial reinforcement ribs 30 are provided extending radially outwardly about mounting aperture 22. These radial reinforcement ribs 30 are integrally molded with main bracket member 12 and serve to provide reinforcement against crushing when mounting main bracket member 12 to engine block 16. Alternatively, a metal crush limiter (not shown) could also be used. Vertical or longitudinal ribs 32 are further provided integrally molded along an arm portion 33 of main bracket member 12. Vertical ribs 32 provide torsional resistance to further strengthen main bracket member 12 and further provide resistance to lateral bending forces.

Main bracket member 12 includes a hose clamping portion 34 for receiving radiator hose 14. Radiator hose clamping portion 34 is generally a C-shaped channel, which is generally positioned perpendicular to and slightly oblique to fastener 18. Radiator hose clamping portion 34 has approximately a 60% closure ratio encapsulating the diameter of radiator hose 14. Radiator hose clamping portion 34, however, does provide limited space about the external diameter of radiator hose 14 to permit radiator hose 14 to translate along the longitudinal axis of radiator hose 14.

As best seen in FIG. 3, radiator hose clamping portion 34 of main bracket member 12 is generally cored out to reduce the mass thereof, leaving a central rib 36 extending about radiator hose clamping portion 34 and a plurality of radial connecting ribs 37 extending from central rib 36 to the edges of radiator hose clamping portion 34.

Radiator hose 14 must be compressed to fit within a throat 38 of radiator hose clamping portion 34; however, once received, radiator hose 14 will remain in radiator hose clamping portion 34 under free-state conditions. Internal pressure within radiator hose 14 will increase the overall diameter of radiator hose 14 during vehicle operation, thereby increasing the interference with radiator hose clamping portion 34. This arrangement serves to retain radiator hose 14 in position during vehicle operation, yet permit some relaxing of the system when the vehicle is not operating.

Additionally, main bracket member 12 may include additional mounting features 40 for receiving and supporting additional vehicle components. These additional vehicle components may be mounted via mounting holes 42 formed adjacent radiator hose clamping portion 34.

The description of the invention is merely exemplary in nature and, thus, variations that do not depart from the gist of the invention are intended to be within the scope of the invention. Such variations are not to be regarded as a departure from the spirit and scope of the invention.

1. A radiator hose bracket for retaining a radiator hose relative to an engine block of a vehicle, said radiator hose bracket comprising:
a main bracket member having a C-shaped hose clamping portion, said C-shaped hose clamping portion being sized to laterally retain the radiator hose by an interference fit and permit free longitudinal movement of the radiator hose;
an aperture disposed through said main bracket member, said aperture sized to receive a fastener therethrough to operably couple said main bracket member to the engine block; and
an anti-rotation feature extending from said main bracket member, said anti-rotation feature engagable with a corresponding feature extending from the engine block.

2. The radiator hose bracket according to claim 1 wherein said anti-rotation feature comprises:
a pair of finger members extending orthogonally from said main bracket member, said pair of finger members engagable with said corresponding feature extending from the engine block.

3. The radiator hose bracket according to claim 2 wherein said anti-rotation feature further comprises:
a prong member extending from said main bracket member, said prong member defining a longitudinal axis that is generally parallel to an axis of said aperture.

4. The radiator hose bracket according to claim 1, further comprising:
a plurality of radial ribs integrally formed with said main bracket member, said plurality of radial ribs radially extending outwardly from said aperture to provide reinforcement of said main bracket member from compression.

5. The radiator hose bracket according to claim 1, further comprising:
a plurality of longitudinal ribs integrally formed with said main bracket member, said plurality of longitudinal ribs extending longitudinally along said main bracket member to provide reinforcement of said main bracket member from at least torsion.

6. The radiator hose bracket according to claim 1, further comprising:
a plurality of accessory mounting apertures formed adjacent said C-shaped hose clamping portion, said plurality of accessory mounting apertures being sized to receive a fastener therein to retain an accessory to said main bracket member.

7. The radiator hose bracket according to claim 1 wherein said anti-rotation feature is integrally molded with said main bracket member.

8. The radiator hose bracket according to claim 1, further comprising:
a central rib integrally formed with said main bracket member and extending about the periphery of said C-shaped hose clamping portion; and
a plurality of connecting ribs integrally formed with said main bracket member and extending from said central rib to opposing edges of said C-shaped hose clamping portion in a direction generally orthogonal to said central rib.

9. A radiator hose bracket for retaining a radiator hose relative to an engine block of a vehicle, said radiator hose bracket comprising:
a main bracket member having a C-shaped hose clamping portion, said C-shaped hose clamping portion being sized to laterally retain the radiator hose by an interference fit and permit free longitudinal movement of the radiator hose without permitting inadvertent disengagement;
an aperture disposed through said main bracket member, said aperture sized to receive a fastener therethrough to operably couple said main bracket member to the engine block; and
an anti-rotation feature extending from said main bracket member, said anti-rotation feature engagable with a corresponding feature extending from the engine block.

10. The radiator hose bracket according to claim 9 wherein said anti-rotation feature comprises:
a pair of finger members extending orthogonally from said main bracket member, said pair of finger members engagable with said corresponding feature extending from the engine block.

11. The radiator hose bracket according to claim 10 wherein said anti-rotation feature further comprises:
a prong member extending from said main bracket member, said prong member defining a longitudinal axis that is generally parallel to an axis of said aperture.

12. The radiator hose bracket according to claim 9, further comprising:
a plurality of radial ribs integrally formed with said main bracket member, said plurality of radial ribs radially extending outwardly from said aperture to provide reinforcement of said main bracket member from compression.

13. The radiator hose bracket according to claim 9, further comprising:
a plurality of longitudinal ribs integrally formed with said main bracket member, said plurality of longitudinal ribs extending longitudinally along said main bracket member to provide reinforcement of said main bracket member from at least torsion.

14. The radiator hose bracket according to claim 9, further comprising:
a plurality of accessory mounting apertures formed adjacent said C-shaped hose clamping portion, said plurality of accessory mounting apertures being sized to receive a fastener therein to retain an accessory to said main bracket member.

15. The radiator hose bracket according to claim 9 wherein said anti-rotation feature is integrally molded with said main bracket member.

16. The radiator hose bracket according to claim 9, further comprising:
a central rib integrally formed with said main bracket member and extending about the periphery of said C-shaped hose clamping portion; and
a plurality of connecting ribs integrally formed with said main bracket member and extending from said central rib to opposing edges of said C-shaped hose clamping portion in a direction generally orthogonal to said central rib.

17. A radiator hose bracket for retaining a radiator hose relative to an engine block of a vehicle, said radiator hose bracket comprising:
a main bracket member having a C-shaped hose clamping portion, said C-shaped hose clamping portion having first and second ends spaced to define a throat, said throat being smaller than an outer diameter of the radiator hose to laterally retain the radiator hose by an interference fit and permit free longitudinal movement of the radiator hose;
an aperture disposed through said main bracket member, said aperture sized to receive a fastener therethrough to operably couple said main bracket member to the engine block; and
an anti-rotation feature extending from said main bracket member, said anti-rotation feature engagable with a corresponding feature extending from the engine block.

18. The radiator hose bracket according to claim 17 wherein said anti-rotation feature comprises:
a pair of finger members extending orthogonally from said main bracket member, said pair of finger members engagable with said corresponding feature extending from the engine block.

19. The radiator hose bracket according to claim 18 wherein said anti-rotation feature further comprises:
a prong member extending from said main bracket member, said prong member defining a longitudinal axis that is generally parallel to an axis of said aperture.

20. The radiator hose bracket according to claim 17, further comprising:
a plurality of radial ribs integrally formed with said main bracket member, said plurality of radial ribs radially extending outwardly from said aperture to provide reinforcement of said main bracket member from compression.

21. The radiator hose bracket according to claim 17, further comprising:
a plurality of longitudinal ribs integrally formed with said main bracket member, said plurality of longitudinal ribs extending longitudinally along said main bracket member to provide reinforcement of said main bracket member from at least torsion.

22. The radiator hose bracket according to claim 17, further comprising:
a plurality of accessory mounting apertures formed adjacent said C-shaped hose clamping portion, said plurality of accessory mounting apertures being sized to receive a fastener therein to retain an accessory to said main bracket member.

23. The radiator hose bracket according to claim 17 wherein said anti-rotation feature is integrally molded with said main bracket member.

24. The radiator hose bracket according to claim 17, further comprising:
a central rib integrally formed with said main bracket member and extending about the periphery of said C-shaped hose clamping portion; and
a plurality of connecting ribs integrally formed with said main bracket member and extending from said central rib to opposing edges of said C-shaped hose clamping portion in a direction generally orthogonal to said central rib.

25. The radiator hose bracket according to claim 1, wherein said C-shaped clamping portion includes first and second ends spaced to define a throat, said throat being smaller than an outer diameter of the radiator hose.

26. The radiator hose bracket according to claim 9, wherein said C-shaped clamping portion includes first and second ends spaced to define a throat, said throat being smaller than an outer diameter of the radiator hose.
